(19) United States
(12) Patent Application Publication
(10) Pub. No.: US 2018/0153763 A1
(43) Pub. Date: Jun. 7, 2018

(54) Personal Arousing Apparatus

(71) Applicant: Wan-Ting Tseng, Taipei City (TW)

(72) Inventor: Wan-Ting Tseng, Taipei City (TW)

(21) Appl. No.: 15/370,888

(22) Filed: Dec. 6, 2016

(51) Int. Cl. A61H 19/00; A61H 9/00; A61H 11/00; A61H 7/00

(52) U.S. Cl. CPC A61H 19/30; A61H 9/0071; A61H 11/00; A61H 7/002; A61H 2201/1215; A61H 2201/501; A61H 2230/00; A61H 2201/105; A61H 2201/5043; A61H 2201/5097; A61H 2201/165

(57) ABSTRACT

A personal arousing apparatus comprises a plurality of arousing units each provided with a rotating unit or fan in the arousing unit, and a controller for controlling each rotating unit or fan for driving each rotating unit or fan for rotatably massaging the user and for blowing air onto the user's body portion for caressing, arousing, relaxing or pleasing her or him comfortably.

### BACKGROUND OF THE INVENTION

Numerous devices and products are commercially available for enhancing sexual function and sexual arousal. Some of them are non-vibratory adapted for a direct insertion or contact; while the other are vibrators for generating vibration to enhance sexual stimulation of the users. They are only suitable for uses at home. It is not suitable for those introvert users who may feel shy when carrying or using such sexual aid outside her or his home.

Masturbation involves touching, pressing, rubbing or massaging a person's genital area or sexual sensitive body zone. A conventional masturbation aid may help her or his masturbation, but lacking of a gentle, soft, and affectionate-like arousing on her or his body zone.

It is therefore expected to invent a apparatus for arousing the user in a gentle and affectionate-like manner.

### SUMMARY OF THE INVENTION

The object of the present invention is to provide a personal arousing apparatus comprising a plurality of arousing units each provided with a rotating unit or fan in the arousing unit, and a controller for controlling each rotating unit or fan for driving each rotating unit or fan for rotatably massaging the user and for blowing air onto the user's body portion for caressing, arousing, comfort your bodies, relaxing or pleasing her or him comfortably.

### BRIEF DESCRIPTION OF THE DRAWINGS

FIG. 1 is an exploded view of a first preferred embodiment of the present invention.

FIG. 2 is an illustration of the first embodiment of the present invention.

FIG. 3 is a sectional drawing of a second preferred embodiment of the present invention.

FIG. 4 shows a third preferred embodiment of the present invention as modified from FIG. 3.

FIG. 5 shows a fourth preferred embodiment of the present invention, adapted for diffusing pleasant-under agent (mist) outwardly.

FIG. 6 is an illustration when wearing the apparatus of the present invention on a user's wrist.

FIG. 7 shows the apparatus of the present invention as placed on a user's chest portion.

FIG. 8 is a block diagram of the control unit and the related elements of the present invention.

FIG. 9 is a diagram showing the test result when performing the tests on the user's inside arm portions.

FIG. 10 shows another diagram of the test result when performing the tests on the user's neck portions.

### DETAILED DESCRIPTION

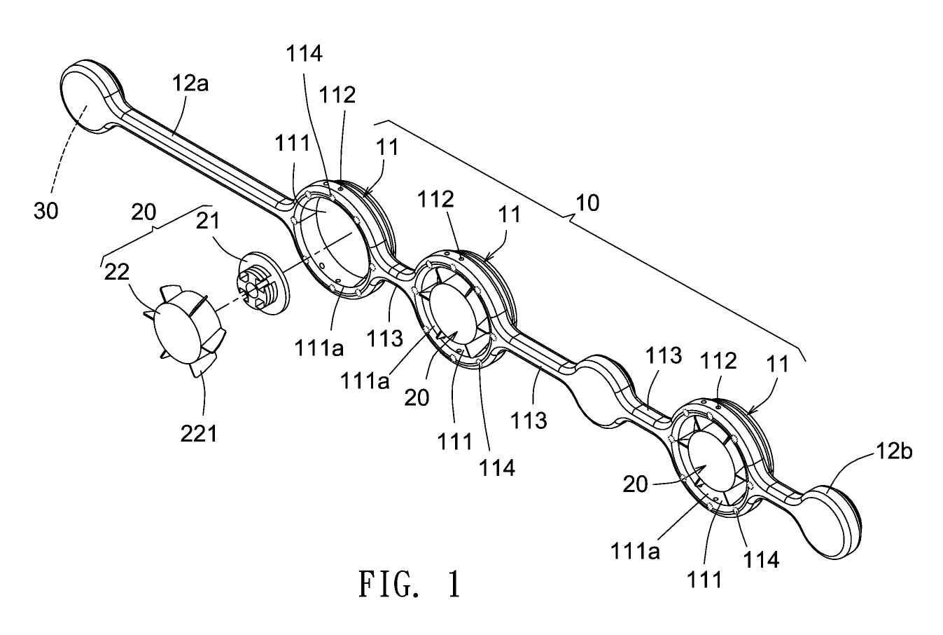

As shown in FIGS. 1-4, a personal arousing apparatus of the present invention comprises: a arousing actuator 10 consisting of a plurality of arousing units 11 and adapted to be worn on a user or wearer so as to caress the user's body portions or organs; a plurality of rotating units 20 each provided in each arousing unit 11 and operatively rotating for driving a medium to caress, comfor, touch, or fondle the user's body portions or organs; and a plurality of control units 30 each operatively powering and controlling each rotating unit 20. The rotating unit 20 may include an air fan, or a mini air fan.

Each arousing unit 11 includes a storing chamber 111 formed in the arousing unit 11 for mounting each rotating unit 20 in each storing chamber 111, a discharge port 111a formed in an opening of the arousing unit 11 for discharging the medium, such as air as driven or blown by the rotating unit 20, through the discharge port 111a to caress the user's body portions or organs. A plurality of massage protrusions 114 are formed on a rim of the discharge port 111a for massage purpose, upon the operation of the rotor or motor of the rotating unit 20 and the vibrations caused during the operation of the rotor or motor may cause “massage” effect on the users.

The arousing actuator 10 may be worn or placed on a user's or wearer's body portions, including: neck, chest, breast, wrist, arm, legs, back, ears, genital or sex organs, or any other body portions, not limited in the present invention.

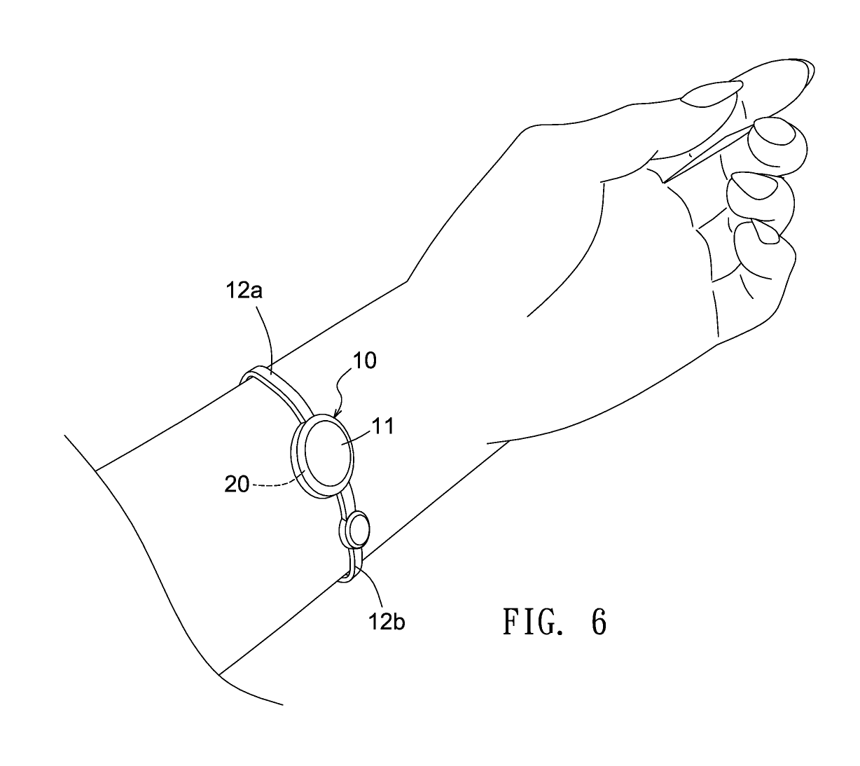

As shown in FIG. 6, the arousing actuator 10 may further include a pair of fastening straps 12a, 12b to be mutually locked, fastened and worn on a wearer's wrist or neck portions. A hanging device (not shown) may be attached to the actuator 10 so that the present invention may be hung on the wearer's neck portion. The fastener strap 12a or 12b may be selected from ribbon, textile strap, chain or cord, not limited in this invention.

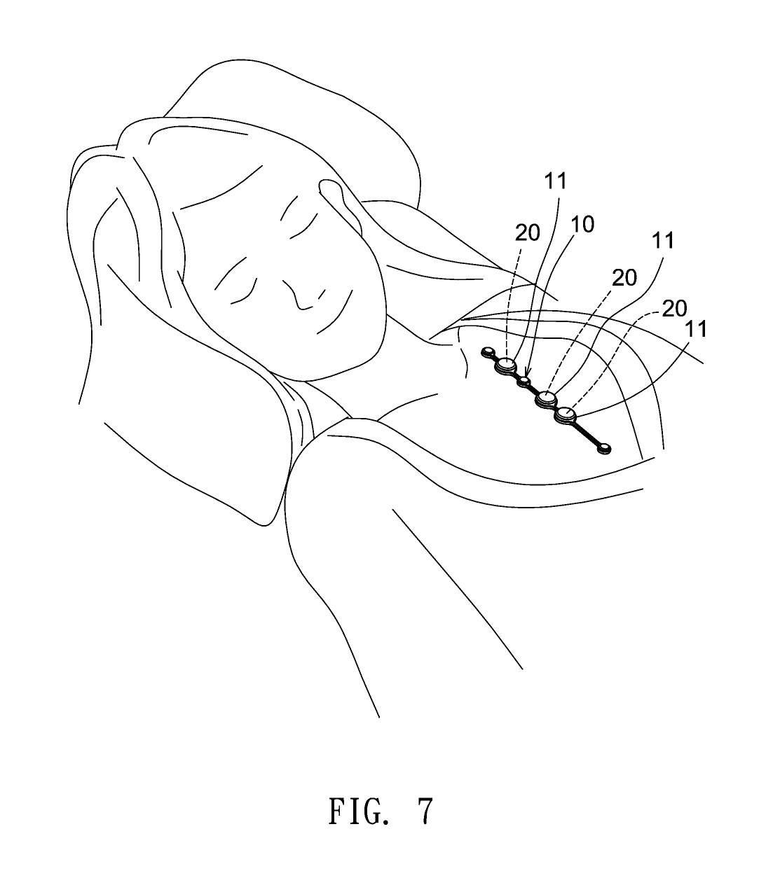

The arousing actuator 10 may be made of silicon rubber, rubber or any other soft, flexible elastomeric materials or polymers. When the user is sitting, or lying, the arousing actuator 10 should be stably placed on the wearer's body portion, not slipping off the wearer's body portion. As shown in FIG. 7, when the user is in supine position, the personal arousing apparatus of the present invention may be put on the user's chest portion, whereby upon the actuation of the rotating units 20 and the arousing units 11, the user may have the feeling to be caressed, fondled or touched gently on her chest.

Such arousing phenomena may be described in detail as follows:
1. The rotating units 20 may include mini air fans, which may blow air onto the user's chest to imitate a comfortable arousing action by someone. The air arousing is a soft fondling on the user.
2. The massage protrusions 114 provided on each arousing unit 11, serving as vibrator massage device when starting the fan motor, may synchronously massage the user's chest, in cooperation with the air arousing by the blowing air as aforementioned.

So, by both of the soft air arousing by air fan and the pressurizing massage by the protrusions 114 on each arousing unit 11, when vibrating by the fan motor, may caress and massage the user more comfortably, and may well stimulate her for a pleasant relaxation.

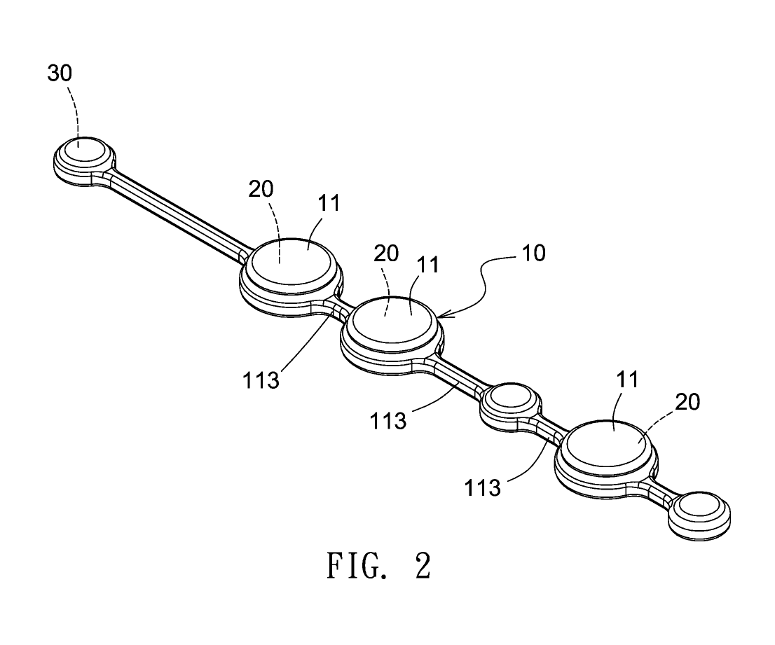

As shown in FIGS. 1 and 2, the personal arousing apparatus of the present invention comprises at least one rotating unit 20 which includes a stator 21 and a rotor 22 rotatably disposed around the stator 21. The rotor (or motor) 22 includes a plurality of fan blades 221 formed on the rotor 22 so as to form an air fan, especially a mini air fan. Upon rotation of the rotating unit 20 (or defined as an air fan), the fan blades 221 will expel and blow a medium (or air) outwardly through the discharge port 111a to “caress” the user's body portion or organ. The medium or air as blown by the rotating unit 20 of the present invention plays like someone's finger or hand, having a gentle trigger, touch, fondle, caress or arouse on the user's body organ. So, the title of the present invention is designated as a personal “arousing” apparatus. Such a arousing on the user's body or organ may trigger or drive her relaxing and pleasing feeling. The arousing unit 11 is formed with plural air inlet holes 112 in the circumference of the arousing unit 11 to allow air to be sucked inwardly and the air is then blown outwardly by the rotating unit 20 as mounted in the arousing unit 11. The protrusions 114 formed on the arousing unit 11, upon operation of the rotating unit 20 to act like a “vibrator” as vibration caused by a rotor or motor of the rotating unit 20, will play a role for massaging the user's body or organ. Such a massage effect may synergetically enhance the arousing effect as caused by the air blown by the rotating unit 20 to thereby comfortably relax or please the user.

According to the preferred embodiments as aforementioned, a plurality of participants are invited for test to obtain an optimum operation data for pleasing the participants. Two categories of tests are provided as follows:
A. The apparatus of the present invention is worn on a user's inside arm portion. 75 participants are tested to obtain the following test results:

TABLE 1

| | No. of Participants of | Rate (%) of |
|---|---|---|
| Air Flow Rate (CFM) | “good feeling” | “good feeling” |
| 0.001 | 0 | 0 |
| 0.1 | 32 | 42.67% |
| 1 | 43 | 57.33% |
| 1.5 | 63 | 84.00% |
| 2 | 52 | 69.33% |
| 2.5 | 48 | 64.00% |
| 3 | 38 | 50.67% |
| 3.5 | 32 | 42.67% |
| 4 | 25 | 33.33% |
| 4.5 | 18 | 24.00% |
| 5 | 8 | 10.67% |
| 5.5 | 6 | 8.00% |
| 6 | 3 | 4.00% |

Note:
1. CFM = cubic feet per minute.
2. “good feeling” means that the participants have the most comfortable, relaxing, and pleasing feeling at such an air flow rate.

From the above data. (Table 1), more than 42.67% of the participants feel most comfortable as effected by the present invention when the air flow rate is set to be ranging from 0.1˜3.5 CFM. Smaller or larger air flow rate is not suitable for them according to the test result as shown in Table 1.
B. The apparatus of the present invention is worn on a user's neck portion. 78 participants are tested to obtain the following test results.

TABLE 2

| | No. of Participants of | Rate (%) of |
|---|---|---|
| Air Flow Rate (CFM) | “good feeling” | “good feeling” |
| 0 | 0 | 0 |
| 1 | 1 | 1.28% |
| 2 | 6 | 7.69% |
| 2.5 | 17 | 21.79% |
| 3 | 32 | 41.03% |
| 3.5 | 38 | 48.72% |
| 4 | 42 | 53.85% |
| 4.5 | 46 | 58.97% |
| 5 | 32 | 41.03% |
| 5.5 | 23 | 29.49% |
| 6 | 12 | 15.38% |
| 7 | 4 | 5.13% |

Note:
“CFM” and “good feeling” may refer to Note of Table 1.

From the data as shown in Table 2, more than 41.03% of the participants feel most comfortable when wearing the present invention at an air flow rate ranging from 3˜5 CFM. Table 1 and 2 just show the statistic data of the optimum air flow rate as blown and acted by the present invention. However, each individual user may adjust her or his personal preferred value (air flow rate), not limited in this invention.

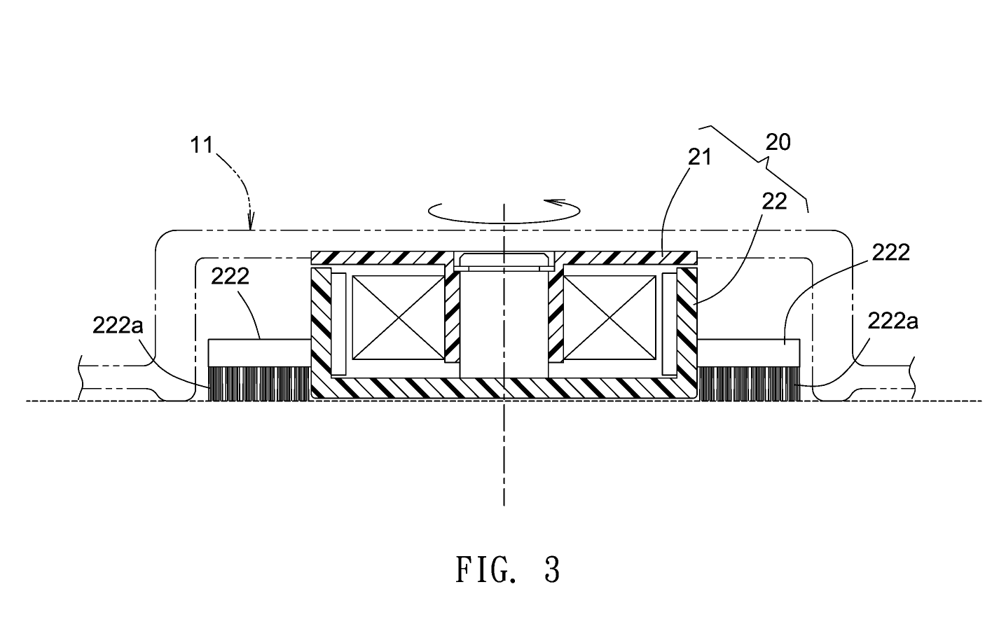

As shown in FIG. 3, the apparatus of the present invention comprises at least a rotating unit 20, including a stator 21 and a rotor 22 rotatably disposed about the stator 21, a fiddling portion 222 for fiddling, rubbing, arousing or fondling the user's body portion or organ mounted on the arousing unit 11. The fiddling portion 222 may include soft or fine bristles or hairs 222a formed thereon for gentle fiddling or fondling on the user's body.

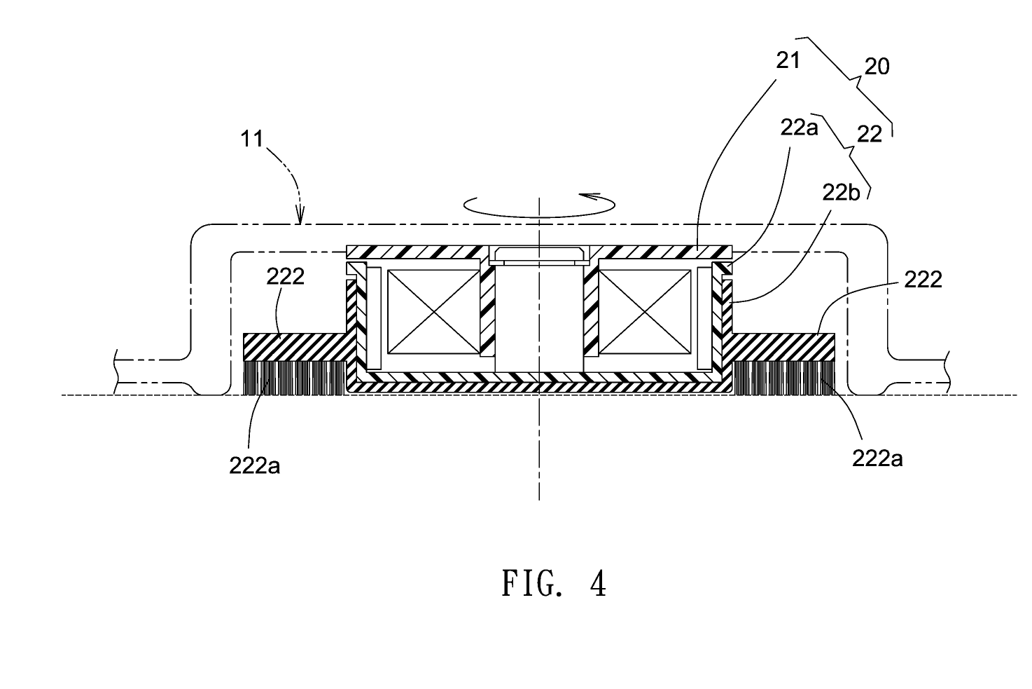

As shown in FIG. 4, the fiddling portion 222 is secured to an outer shell 22b which is detachably mounted to an inner shell 22a; both shells 22b, 22a forming as the rotor 22 of the rotating unit 20. The outer shell 22b may be detached from the inner shell 22a for cleaning or maintenance.

The fiddling portion 222 may be integrally formed with the outer shell 22b. The outer shell 22b and the fiddling portion 222 may be made of plastic, silicon rubber or rubber materials. The bristles or hairs 222a may be made of natural bristles or hairs, or artificial bristles or hairs.

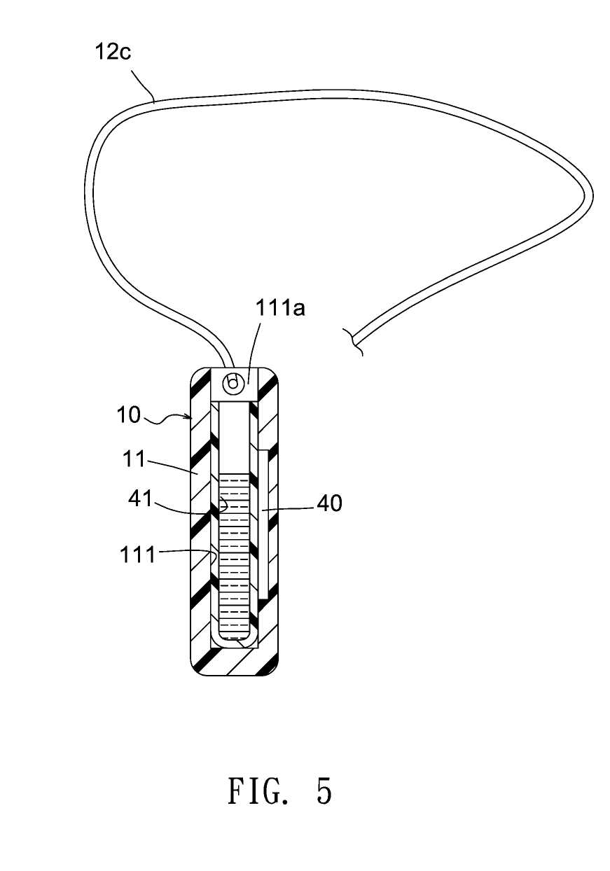

As shown in FIG. 5, the apparatus of the present invention further comprises a vibrator 40 which is secured in a arousing unit 11 of the actuator 10, a pleasant-agent box 41 stored in the storing chamber 111 of the arousing unit 11 for diffusing and releasing vapor or mist of pleasant agent (namely, a pleasant-odor diffusing agent capable for releasing pleasant or fragrance odor) outwardly through the port 111a so as to make the user's feel of good mood or well-being. A strap 12c may be provided for wearing or carrying.

The pleasant-odor box 41 may release or diffuse the pleasant-odor diffusing agent, which may be a perfume, an essential oil, an aromatherapy liquid, mist, spray or vapor, for triggering the user's smell or related organs for relaxing or pleasing the user psychologically or physically. The vibrator 40 may cause vibrations to increase the molecular collision in the diffusing agent to help its vaporization for quickly releasing fragrant vapor or mist outwardly.

As shown in FIG. 2, the arousing actuator 10 of the present invention comprises said plurality of arousing units 11, having the neighboring two arousing units 11 connected by a linking arm 113 which may be formed as a chain, a cord or a string adapted for a comfortable wearing or intimate holding on a user's carved body portion, such as on a chest portion as shown in FIG. 7. The control unit 30 is electrically connected to each arousing unit 11 and each rotating unit 20 through the linking arms 113 or through the straps 12a, 12b as shown in FIG. 1. The linking arm 113 may also be connected between the control unit 30 and the arousing unit 11.

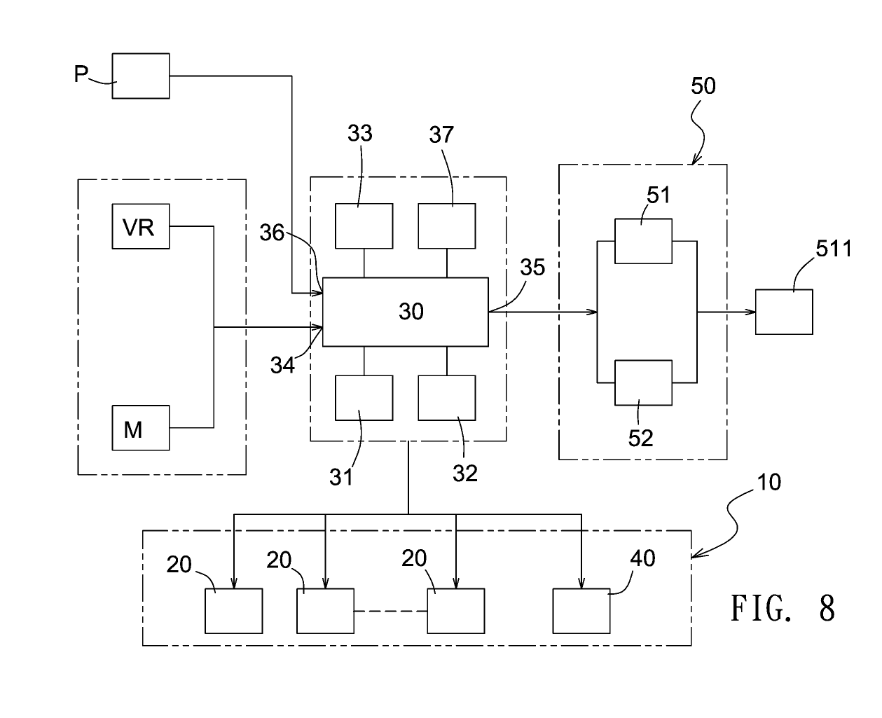

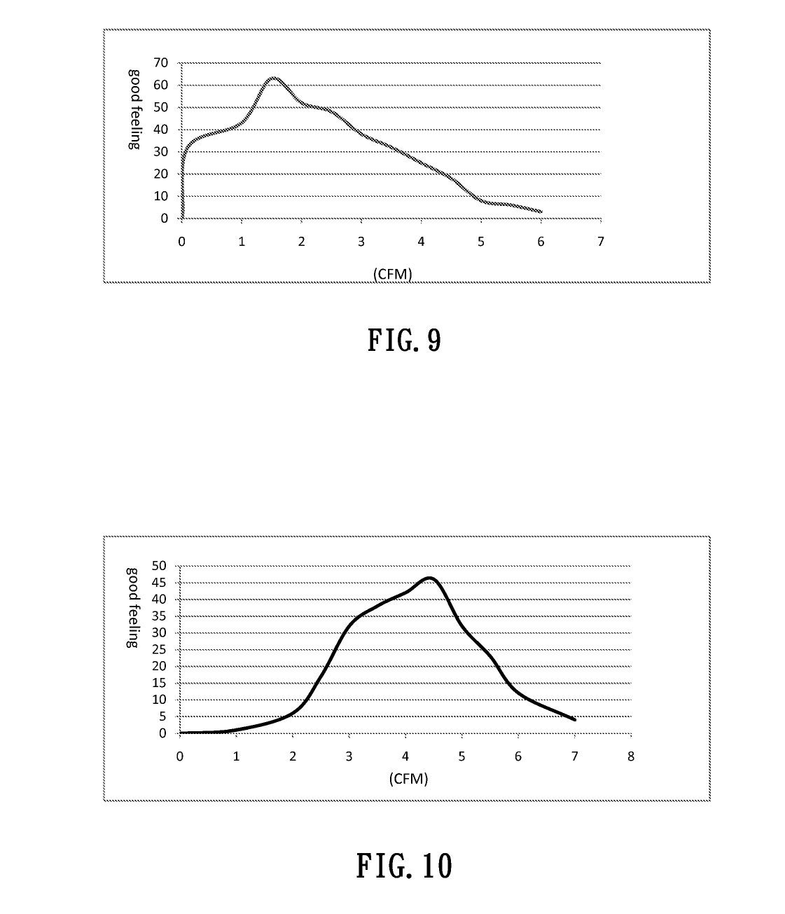

As shown in FIG. 8, the personal arousing apparatus of the present invention further comprises a control unit (or driving control unit) 30, including a physiological sensor 31 adapted for measuring the physiological changes of the user for thereby producing the physiological signals in response to the physiological changes.

As shown in FIG. 8, the control unit 30 further comprises a control module 32, adapted for receiving the physiological signals as emitted from the physiological sensor 31 so as to control the rotating modes of the rotating units 20.

The physiological sensor 31 may detect plural physiological signals, such as: heart beat rate, blood pressure, body temperature, oxygen content in blood; each individual signal thereof or the combination of the above signals, not limited in this invention.

The control unit 30 may drive and control each rotating unit 20 in accordance with a plurality of control modes including synchronous equal speed rotation, different speed rotation, intermittent rotation, regular subsequent rotation in order, or random rotation, to create different air flow for different moods, different air pressure or air flow rate so as to trigger, caress or touch the user's body gently.

As shown in FIG. 8, the control unit 30 further comprises a display 33 for displaying the physiological signal as sensed by the physiological sensor 31 or the corresponding signal of rotating mode of each rotating unit 20. Such a corresponding signal may include signal of a light emitting element, or multi-media signals of words, figures, pictures, cartoons, motion pictures or other audio-video signals.

The display 33 may be a light emitting element such as LED or a display monitor. For instance, the number of the light emitting elements or colors as illuminated may display the user's physiological signal status or show the rotating modes status of each rotating unit 20. Or, via the multi-media signals of words, figures, cartoons, pictures, motion pictures, the user's physiological signal or the status of the rotating unit 20 may be displayed. On the monitor, the user's heart rate, blood pressure, body temperature or oxygen content in blood may be presented as data, linear graphs or bar graphs. Also, the corresponding motion pictures, pictures, or the cartoons, showing the rotating modes of the rotating unit 20 may be presented.

The control unit 30 comprises: an input port 34 for receiving wired signals or wireless signals for controlling the rotating modes of each rotating unit 20, for instance for increasing the rotating speed, reducing the speed, intermittent rotation, random rotation or rotations in order. The input port 34 may be connected to VR, a virtual reality, to simulate the feelings as a real touch, caress, air/wind blow, or vibration on the user's body by someone or the sexual partner, in cooperation with the controlled operations of the rotating modes of each rotating unit 20.

The input port 34 may also be connected to a mobile device M, as shown in FIG. 8 so that the user may control the operations remotely or at a nearby place.

The control unit 30 further comprises an output port 35 for emitting the status data signals as recorded in the control unit 30 to a receiver 50. Such status data may include the basic information of the user, date, time, physiological data, the rotating modes of the rotating units 20, and the other related data.

The output port 35 may be connected to the receiver 50 through blueteeth, Wi-Fi, or wired communication systems.

The input port 34 or the output port 35 may include a USB connector or any other connectors, not limited in this invention.

The receiver 50 may include a mobile device 51, a cloud servo 52, or any other receiving devices. The receiver 50 may include a receiver display 511 which may show the related data by illuminating light emitting elements or by displaying words, figures, graphs, cartoons, pictures or motion pictures or other multi-media, showing the status data signals as recorded by the control unit 30.

The control unit 30 comprises a power-source input port 36 for inputting an externally connected power source P to supply power to the rotating units 20. The control unit 30 may also be built in with power source of batteries or rechargeable batteries for powering the rotating units 20.

The control unit 30 may further comprise a control panel 37 which is provided with control keys corresponding to the rotating modes of the rotating units 20.

In operating the present invention, the rotating units 20 of the arousing actuator 10 may be controlled or operated to gently trigger, caress or touch the user's body portions or organs by air flow, sound transmission, vibrations, odors, and other arousing or fondling actions so as to relax or please the user. The virtual reality (VR) or any other simulation apparatus may be aided to better simulate the arousing actions in order to massage, fondle, or caress the user, or to help masturbation for the user, thereby relaxing, pleasing, soothing or stimulating the user comfortably or happily.

The present invention has the following advantages:
1. Besides its rotational or vibrational massage or rubbing effect, the air as blown from the rotating unit 20 and arousing unit 11 may caress the user softly, gently and affectionately to be more comfortable than any conventional massage devices.
2. For masturbation purpose, the apparatus of this invention may be conveniently carried or used. Since it is not a shaped big sexual device, it may be carried and used, without embarrassment or shy feeling especially better for those introvert users.
3. The appearance is compact and may be designed as necklace, bracelet, or any fashionable items, thereby being conveniently carried, worn or used fashionably. Also, it may be used anywhere on a user's body or organ, either by wearing, hanging or just placing on the user's body.
4. When used as a sexual aid or stimulation device, it is elegant, artistic and more conservative.
5. Multiple “media” may be selected for the arousing, including: air, motor, vibrator, bristles, odors and simulating electronic devices, for enriching the arousing effect.

The present invention may be further modified without departing from the spirit and scope of the present invention. For example, the protrusions 114 formed on the arousing unit 11 may be removed or eliminated, if the user does not like the protruded parts which may cause a little sticking (pain) feeling when touched.

I claim:

1. A personal arousing apparatus comprising:
a arousing actuator including at least a arousing unit having a storing chamber formed in said arousing unit and having a rim disposed around a discharge port of said arousing unit and formed with or without a plurality of protrusions on said rim of said arousing unit;
at least a rotating unit mounted in said storing chamber in said arousing unit and operatively driving a medium towards a user's body portion; and
a control unit connected to said rotating unit and electrically powering said rotating unit and operatively controlling the operation of said rotating unit;
whereby upon operation of said rotating unit, said rotating unit will drive said medium to arouse the user's body portion, and said arousing unit, as vibrated by said rotating unit when operated, will massage the user's body portion.

2. The personal arousing apparatus according to claim 1, wherein said control unit operatively drives said rotating unit in a plurality of rotating modes, which includes a synchronous equal-speed rotation, different-speed rotation, intermittent rotation, subsequent rotation in order, and random rotation.

3. The personal arousing apparatus according to claim 1, wherein said arousing actuator further comprises at least two fastening straps, which are mutually locked or unlocked.

4. The personal arousing apparatus according to claim 1, wherein said rotating unit includes a stator and a rotor rotatably disposed around said stator, said rotor provided with fan blades on said rotor, whereby upon rotation of said rotating unit, said fan blades will drive said medium, which is air, outwardly though said discharge port of said arousing unit for arousing the user's body portion.

5. The personal arousing apparatus according to claim 4, wherein said medium of air has an air flow rate, ranging from 1 through 5 cubic feet per minute.

6. The personal arousing apparatus according to claim 1, wherein said rotating unit includes a stator and a rotor rotatably disposed around said stator, a fiddling portion formed on said rotor and operatively fiddling or rubbing the user's body portion upon rotation of said rotor and said fiddling portion.

7. The personal arousing apparatus according to claim 6, wherein said fiddling portion includes a plurality of bristles or hairs formed on said fiddling portion for fiddling or rubbing the user's body portion.

8. The personal arousing apparatus according to claim 6, wherein said rotor includes an inner shell rotatably disposed around said rotor; and an outer shell secured to said inner shell, having said fiddling portion secured to said outer shell.

9. The personal arousing apparatus according to claim 8, wherein said fiddling portion is integrally formed with said outer shell.

10. The personal arousing apparatus according to claim 1, wherein said arousing actuator further comprises a vibrator formed in said arousing unit, and a pleasant-agent box stores in the storing chamber of said arousing unit for diffusing and releasing pleasant agent outwardly.

11. The personal arousing apparatus according to claim 1, wherein said apparatus further comprises a plurality of flexible linking arms, each said linking arm provided for connecting two neighboring arousing units, or said linking arm provided for connecting one said arousing unit and one said control unit.

12. The personal arousing apparatus according to claim 1, wherein said control unit comprises a physiological sensor, operatively measuring a physiological change of the user and producing a corresponding physiological signal in response to said physiological change as sensed by said sensor.

13. The personal arousing apparatus according to claim 12, wherein said control unit further comprises a control module for receiving the physiological signal from said physiological sensor for controlling or operating a rotating mode of each said rotating unit.

14. The personal arousing apparatus according to claim 12, wherein said control unit further comprises a display operatively displaying the corresponding physiological signal from said physiological sensor.

15. The personal arousing apparatus according to claim 13, wherein said control unit further comprises a display operatively displaying a corresponding physiological signal of the rotating mode of each said rotating unit.

16. The personal arousing apparatus according to claim 14, wherein said display includes a light emitting element for numeric or color illumination, and a display monitor for showing words, figures, cartoons, pictures, motion pictures, and multi-media signals; adapted for showing the corresponding physiological signals.

17. The personal arousing apparatus according to claim 1, wherein said control unit comprises an input port for receiving a wired signal or a wireless signal for operating and controlling a rotating mode of each said rotating unit.

18. The personal arousing apparatus according to claim 1, wherein said control unit comprises an output port for outputting a status information as recorded by said control unit to a receiver.

19. The personal arousing apparatus according to claim 18, wherein said receiver includes a receiver display.

20. The personal arousing apparatus according to claim 1, wherein said control unit is electrically connected with a control panel, said control panel having a plurality of control keys each corresponding to a rotating mode of each said rotating unit for controlling each said rotating unit.
